(19) United States
(12) Patent Application Publication
(10) Pub. No.: US 2026/0133322 A1
(43) Pub. Date: May 14, 2026

(54) Systems and Methods for Distributed Dense Network Processing of Satellite Positioning Data

(71) Applicant: Swift Navigation, Inc., San Francisco, CA (US)

(72) Inventors: Fergus NOBLE, San Francisco, CA (US); Anthony COLE, San Francisco, CA (US)

(73) Assignee: Swift Navigation, Inc., San Francisco, CA (US)

(21) Appl. No.: 18/936,131

(22) Filed: Nov. 4, 2024

Related U.S. Application Data
(63) Continuation of application No. 18/210,455, filed on Jun. 15, 2023, now Pat. No. 12,164,041.
Application No. 18/210,455 is a continuation of application No. 17/347,874, filed on Jun. 15, 2021, now Pat. No. 11,714,196.
Application No. 17/347,874 is a continuation of application No. 16/589,932, filed on Oct. 1, 2019, now Pat. No. 11,061,141.
Application No. 16/589,932 is a continuation of application No. 16/195,427, filed on Nov. 19, 2018, now Pat. No. 10,473,790.
(60) Provisional application No. 62/587,741, filed on Nov. 17, 2017.

(51) Int. Cl. G01S 19/07; G01S 19/04; G01S 19/06; G01S 19/25; G01S 19/40

(52) U.S. Cl. CPC G01S 19/072; G01S 19/04; G01S 19/06; G01S 19/07; G01S 19/256; G01S 19/40

(57) ABSTRACT

RTK-GPS (realtime kinematic GPS) is one of the most precise positioning technology, with which users can obtain cm-level accuracy of the position in realtime by processing carrier-phase measurements of GPS signals. RTK-GPS has been already utilized for many applications like surveying, construction, agriculture and transportation. Recently, some researchers have tried to apply RTK-GPS to precise navigation of a mobile vehicle. On the condition under the clear sky, RTK-GPS provides fair performance even in the mobile environment. The performances includes availability of solutions, accuracy, TTF (time to fix), and reliability of integer ambiguity resolutions. However, in urban area like in a downtown street, RTK-GPS shows poor performance. One reason of the performance degradation on such condition is cycle slips. Cycle slips are defined as the discontinuities in the measured carrier-phase caused by loss-of-lock of signal tracking in GPS receivers. A sudden jump of the carrier-phase measurement forces the integer ambiguity discontinuity. The Main sources of the cycle slips are obstructions of GPS signals due to buildings, trees or bridges. So the cycle slips much more occur in mobile environment than in static conditions. In the most of the RTK-GPS receivers, once a cycle slip detected, the estimated integer ambiguity is reset to the initial state. This reinitialization process often takes a few minutes, so the precise solution is not provided in the period. With frequent cycle slips, the availability of the RTK-GPS solutions becomes very low. Additionally, it is not easy to recognize a small cycle slip in the mobile environment. The miss-detection of the cycle slip much degrades the RTK-GPS accuracy. Reliable cycle slip detection is more important on this situation. One of the major technical issues for the mobile environment RTK-GPS is to overcome the cycle slips.

For mobile vehicle navigation with GPS, a low-cost MEMS (micro-electro-mechanical systems) IMU (inertial measurement unit) is sometimes integrated to improve the performance. In such GPS/IMU integrated system, the IMU is used to obtain user positions and velocities during the GPS signal outages. For mobile environment RTK-GPS, this IMU integration is also effective to improve the navigation conditions. In this study, we employed tightly coupled GPS/IMU integration in order to detect and repair the cycle slips for RTK-GPS. As for the tightly coupled GPS/IMU integration, the user position, velocity and attitude are estimated by EKF (extended Kalman Filter) by using both of GPS and IMU measurements. The sensor biases of the gyros and accelerometers of the IMU are also incorporated in the filter, because sensor biases of a MEMS IMU are relatively large and time-varied. In addition to these unknown states, the double-differenced integer ambiguities are estimated in the case of RTK-GPS. The estimated float ambiguities by EKF are resolved into integer value by a usual integer ambiguity resolution way for RTK-GPS.

In this study, in the measurement update of EKF, pre-fit residual of the double-differenced carrier-phase measurement, that is the difference between the predicted and observed state, is compared to the pre-defined threshold for the cycle slip detection. The measurement with larger residual than the threshold is marked as a candidate of the phase discontinuity by a cycle slip. After all the checks, the algorithm enters to the cycle slip repair process. The mount of the each cycle slip has usually the integer value of cycle. So the cycle slip amount as the unknown parameters, the integer vector search process runs to obtain the best estimated integer vector to minimize the least square residuals according to the covariance matrix of the predicted receiver position. To reduce computational cost to solve this ILS (integer least square) problem, the well known efficient strategy LAMBDA is employed to search proper integer vector in this study. Once best solution of the integer vector obtained, it is validated by simple ratio-test with the best and the second best solutions of ILS. If this discrimination test is passed, the states of the carrier phase integer ambiguities are updated by adding the integer vector to repair the cycle slips. If the test failed, the integer ambiguities are reinitialized and restart estimation process from guess estimation values. This proposed cycle slip detection and repair process can be applied to usual RTK-GPS algorithm without the IMU. However, it is hard to provide good performance without an IMU because of the low accuracy of the predicted user position.

We made some field tests to demonstrate and evaluate proposed GPS/IMU integration scheme to detect and repair cycle slip for mobile environment RTK-GPS, NovAtel OEM-V dual-frequency GPS receivers were used for both of the mobile receiver (rover) and the reference station. The rover GPS antenna is mounted to the rooftop of a car. Analog Devices AD16354 6-DOF MEMS IMU device are also fixed on the car body. The rover receiver and IMU were connected to a laptop PC to record raw measurement data. At first we drove the car around the area with clear sky and few obstructions to acquire the raw measurement data of GPS and IMU. We processed the raw measurements of only GPS in the simulated RTK-GPS mode of RTKLIB. RTKLIB is a GPS post processing analysis software developed by the authors but has no function of the IMU data handling originally. Under such good condition, few cycle slips occurred and the RTK-GPS solutions showed the smoothed ground track. Next, we added the artificial integer cycle jumps to the raw carrier phase measurement of GPS to simulate the cycle slips. In this case, the availability of precise solution much decreased and some miss-detections of the cycle slips caused the sudden jumps of the car track. Furthermore, we implemented the proposed tightly coupled GPS/IMU integration and cycle slip detection and repair functions described above. The cycle slip detection and repair function with the IMU could fairly detect and repair the simulated cycle slips and made the ground track of the solutions smooth. The evaluation results are also demonstrated in more realistic situations like at the downtown streets with many cycle slips.

### CROSS-REFERENCE TO RELATED APPLICATIONS

This application is a continuation of U.S. patent application Ser. No. 18/210,455 filed 15-Jun.-2023, which is a continuation of U.S. patent application Ser. No. 17/347,874 filed 15-Jun.-2021, which is a continuation of U.S. patent application Ser. No. 16/589,932, filed 01-Oct.-2019, which is a continuation of US Application patent application Ser. No. 16/195,427, filed on 19-Nov.-2018, now issued as U.S. Pat. No. 10,473,790, which claims the benefit of US Provisional Application Ser. No. 62/587,741, filed on 17-Nov.-2017, all of which are incorporated in their entirety by this reference.

### TECHNICAL FIELD

This invention relates generally to the satellite positioning field, and more specifically to new and useful systems and methods for distributed dense network processing of satellite positioning data.

### BACKGROUND

Being able to perform high precision satellite positioning is important for a wide variety of applications. Unfortunately, current GPS solutions are often either inaccurate or require processor power beyond the capabilities of inexpensive hardware (either locally or in the cloud). A number of solutions have been proposed to address this problem, including Network Real Time Kinematic (Network RTK) satellite positioning. Unfortunately, in traditional methods of Network RTK, the input parameter space increases non-linearly with the size of the network, making it very computationally costly to increase the network size (and thus coverage area and/or positioning accuracy). Therefore, there is the need in the satellite positioning field to create systems and methods for distributed dense network processing of satellite positioning data. This invention provides such new and useful systems and methods.

### BRIEF DESCRIPTION OF THE FIGURES

FIG. 1 is a diagram representation of a system of an invention embodiment;

FIGS. 2A and 2B are example representations of ionospheric effect modeling;

FIG. 3 is an example representation of GNSS effect interpolation; and

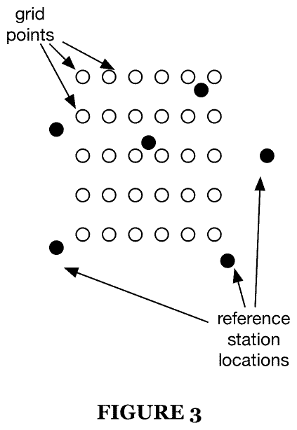

FIG. 4 is a chart representation of a method of an invention embodiment.

### DESCRIPTION OF THE INVENTION EMBODIMENTS

The following description of the invention embodiments of the invention is not intended to limit the invention to these invention embodiments, but rather to enable any person skilled in the art to make and use this invention.

### 1. Traditional GNSS, PPP, and RTK

Traditional satellite positioning systems (e.g., standard GNSS) work by attempting to align a local copy (at a receiver) of a pseudorandom binary sequence with a satellite-transmitted copy of the same sequence; because the satellite is far from the receiver, the signal transmitted by the satellite is delayed. By delaying the local copy of the sequence to match up with the satellite-transmitted copy, the time it takes the signal to travel from the satellite to the receiver can be found, which can in turn be used to calculate the distance between the satellite and receiver. By performing this process for multiple satellites (typically four or more), a position of the receiver relative to the satellites can be found, which can in turn be used to find the position in a particular geographic coordinate system (e.g., latitude, longitude, and elevation). Typical GNSS systems can achieve at best 2 m accuracy in positioning.

For many applications (e.g., guidance for human-carrying autonomous vehicles/drones/agricultural equipment, GPS/GNSS research, surveying), this level of accuracy is woefully inadequate. In response, two position correction algorithms have been developed: precise point positioning (PPP) and real time kinematic (RTK).

Instead of solely using the positioning code broadcast by satellites, PPP and RTK also make use of satellite signal carrier phase to determine position. While much higher accuracy is possible using carrier phase data, accurately determining position of a mobile receiver (i.e., the receiver for which position is to be calculated) requires accounting for a number of potential sources of error. Further, carrier phase measurements are ambiguous; because the carrier signal is uniform, it may not be possible to differentiate between a phase shift of φ and 2πN+φ using phase measurements alone, where N is an integer. For example, it may be difficult to determine the difference between a phase shift of a radians and a phase shift of 3π radians (or −π, 5π, etc.).

PPP attempts to solve this issue by explicitly modeling the error present in mobile receiver phase and code measurements. Some errors are global or nearly global (e.g., satellite orbit and clock errors); for these errors, PPP typically uses correction data with highly accurate measurements. However, for local errors (i.e., error that is substantially dependent on mobile receiver location), PPP is only capable of very rough modeling. Fortunately, many local errors change slowly in time; resultantly, PPP can achieve high accuracy with only a single receiver, but may require a long convergence time to precisely determine local errors. As the terms are used in the present application, “global error” refers to any error that does not vary substantially across multiple reference stations within a region, while “local error” refers to error that does vary substantially across multiple reference stations (because the error is specific to a reference station and/or because the error varies substantially over position within the region). As this error pertains to positioning, such errors may also be referred to as “global positioning error” and “local positioning error”.

RTK avoids a large majority of the modeling present in PPP by use of GNSS reference stations (with precisely known locations); since a reference station is local to the mobile receiver, differencing the reference station and mobile receiver signals can result in greatly reduced error. The result is that RTK solutions can converge much more quickly than PPP solutions (and without the high accuracy global corrections data needed by PPP). However, RTK solutions require the presence of base stations near a mobile receiver.

### 2. System

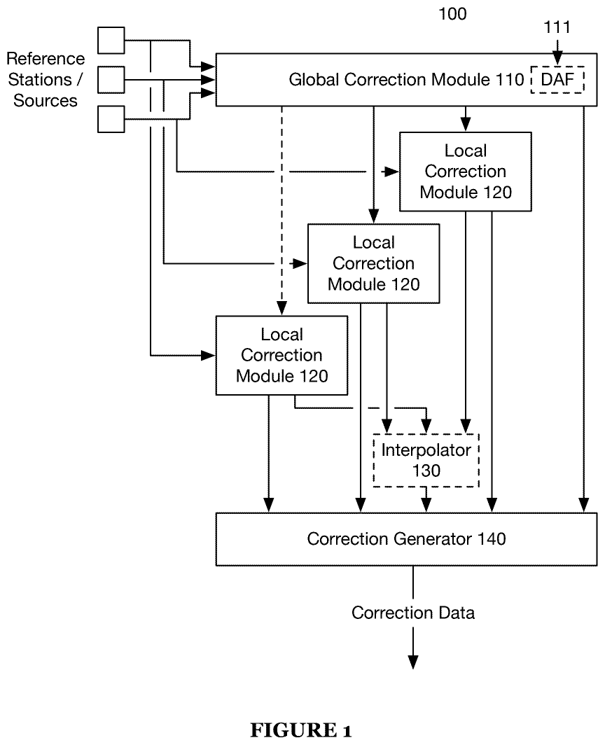

A system 100 for distributed dense network processing of satellite positioning data includes a global correction module 110, a plurality of local correction modules 120, and a correction generator 140, as shown in FIG. 1. The system 100 may additionally include one or more interpolators 130. Note that the inter-module connections as shown in FIG. 1 are intended as non-limiting examples, and the components of the system 100 may be coupled in any manner. For example, data from the global correction module 110 may be used to initialize local correction modules 120, may be passed to the correction generator 140 via local correction modules 120, may be passed directly to the correction generator 140, and/or may be utilized by the system 100 in any other manner.

The system 100 functions to generate correction data to be used by a mobile GNSS (Global Navigation Satellite System) receiver or any other GNSS receiver for which position/velocity/timing data correction is desired. Such a receiver (henceforth referred to as a mobile receiver) may operate on any satellite navigation system; e.g., GPS, GLONASS, Galileo, and Beidou. The correction data is preferably used to improve GNSS solution accuracy, and may take the form of PPP corrections, RTK corrections, or any other type of corrections (discussed in the section on the correction generator 140).

Flexibility in the form of corrections data is an inherent and distinguishing aspect of the system 100 over traditional position correction systems. Rather than attempting to generate corrections solely from a small set of high-quality global reference stations (as in PPP) or by comparing data in mobile receiver / reference station pairs (as in RTK), the system 100 collects data from reference stations (and/or other reference sources), and instead of (or in addition to) applying this data directly to generate connections, the data is used to generate both a global correction model (in the global correction module 110) and a number of local correction models (in local correction modules 120). Output of these models are then passed to the correction generator 140, which can use said output to generate correction data in any form. Further, the correction generator 140 may cache and/or (with use of the interpolator 130) spatially interpolate corrections data to provide high quality corrections to mobile receivers regardless of correction capability (e.g., whether the receiver can process RTK/PPP corrections) and location of individual base stations.

By operating in this manner, the system 100 may provide a set of corrections that (while usable with PPP receivers) suffers from little of PPP's long convergence time issues, with solution complexity scaling directly with the number of reference stations N (unlike RTK, in which solution complexity scales at least with the number of possible pairs; i.e., N². In fact, many current solutions scale with N³ or worse). Further, since corrections are preferably calculated using local correction models that may depend on any number of single reference stations (rather than specific reference station pairs), corrections are substantially more robust to loss of a base station.

Further, the flexible nature of the system 100 enables some functions (such as spatial interpolation and caching) to be performed much more generally than would be possible with RTK; while the concept of a “virtual reference station” is known within RTK (also referred to as a “pseudo reference station”), virtual reference stations typically involve the interpolation of RTK corrections data in real time (and, as discussed before, error correction scales in complexity with N²). In contrast, interpolation in the system 100 can be limited to specific aspects of global and/or local corrections models, providing more robustness to error and better insight as to error causes. Further, unlike RTK, which requires real-time corrections data, the model-based system 100 may cache or otherwise retain model parameters even when data is limited (e.g., when a reference station suddenly becomes unavailable).

The system 100 is preferably implemented in software as part of a networked distributed computing system, but may additionally or alternatively be implemented in any manner.

The global correction module 110 functions to maintain one or more global correction models. Global correction models preferably accomplish two functions-correcting for global error (i.e., error in GNSS positioning that does not vary substantially in space) and error-checking/seeding local error estimates (where local error refers to error that does vary substantially in space or per GNSS receiver). Note that seeding here refers to providing a coarse estimate as a starting point for further refinement.

The global correction module 110 preferably takes as input raw data from reference stations and the mobile receiver (e.g., carrier phase data, pseudorange data, reference station location etc.) but may additionally or alternatively take in processed data from reference stations and/or the mobile receiver (e.g., positioning code data) or data from any other source (e.g., PPP global corrections data sources on the internet, calibration data for particular satellites or receiver types from a manufacturer or other source, satellite orbit data, satellite clock data).

The reference stations utilized by the system 100 are preferably public reference stations, but may additionally or alternatively be private reference stations or any other suitable reference stations.

Reference stations preferably have a location known to a high degree of accuracy. Reference station location is preferably the location of the antenna used to receive satellite signals. Reference station location may be determined in any manner yielding a high degree of accuracy; for example, reference station location may be determined by a number of receivers set around the reference station at vertical and horizontal reference points. Note that while reference stations are preferably fixed in location, they may additionally or alternatively be mobile. Station position is preferably re-determined to high accuracy before moved reference stations re-start providing phase data; additionally or alternatively, reference stations may provide phase data before location re-determination (for example, for use in attitude estimation; alternatively, data may be provided but not used). As another alternative, reference stations may not provide absolute location data at all if not needed; for example, absolute location data of the reference station may not be needed for applications including attitude estimation. Note that fixed reference stations may, over time, “self-survey” their own positions to a reasonably high degree of accuracy.

Reference stations preferably provide phase data for multiple satellite signals and the location of the reference station via the internet, but may additionally or alternatively provide data by any other suitable method (e.g., transmission by UHF-band radio modem). Reference station data is preferably made available directly to the system 100, but may additionally or alternatively be processed or aggregated before being made available to the system 100.

Reference stations preferably have one or more satellite receivers and generate corrections based on those receivers. The number and quality of satellite receivers used by a reference station (or other factors, like antenna type/size/location) may determine the accuracy of reference station data. Reference stations (or other sources of reference station data; e.g., a reference source that creates correction data from multiple reference stations) may be ordered or grouped by reference station quality (e.g., accuracy of corrections) and/or locality (e.g., if corrections are desired for a particular mobile receiver, reference stations may be ordered or grouped by distance to that receiver).

The global correction module 110 preferably explicitly models the effects of global parameters on GNSS navigation. These parameters preferably include satellite clock error, satellite orbit error, satellite hardware bias, satellite antenna phase windup, phase center offset (PCO), and phase center variation (PCV) (all of which are per satellite, but generally do not vary spatially), solid earth tides, solid earth pole tides, ocean tidal loading (which vary spatially and temporally, but in a predictable manner), as well as coarse global models of ionospheric and tropospheric effects (in this case, global models may not be accurate enough by themselves to model ionospheric and tropospheric effects, but they provide a starting point for later refinement). Additionally or alternatively, the global correction module 110 may model the effects of any parameters on GNSS signals as received by a mobile receiver or a reference station. The global correction module 110 preferably additionally maintains uncertainty estimates for at least some global parameters; additionally or alternatively, the global correction module 110 may not maintain uncertainty estimates.

Note that for receivers used in generating/updating the global model, the global correction module 110 may additionally or alternatively model effects unique to those receivers; e.g., receiver clock error, receiver hardware bias, and receiver antenna phase windup/PCO/PCV (which are unique to a given receiver but not directly dependent on location).

The plurality of local correction modules 120 function to maintain local correction models. Local correction models preferably correct for spatially local variance of effects on GNSS signals as well as for effects that are specific to particular receivers/reference stations.

Local correction modules 120 preferably correspond to (and receive data from) a single reference station. In some embodiments, a local correction module 120 exists for each reference source or station, such that each local correction module 120 takes input from a unique reference source. Additionally or alternatively, local correction modules 120 may correspond to and/or couple to reference stations in any manner; for example, a local correction module 120 may be used to model a number of reference stations within a particular spatial region. Additionally or alternatively, the system 100 may include one or more local correction modules 120 corresponding to mobile receivers.

A local correction module 120 preferably takes as input raw data from corresponding reference stations/mobile receivers (e.g., carrier phase data, positioning code data, reference station location, pseudorange, navigation data, message data, etc.) but may additionally or alternatively take in processed data from reference stations and/or the mobile receiver (e.g., broadcast ephemerides and almanacs) or data from any other source. The local correction module 120 preferably additionally takes data from the global correction module 120 (e.g., to initialize a local correction model for a new reference station and/or to compensate for global components of local error). Additionally or alternatively, the local correction module 120 may take data from any source (e.g., the local correction module 120 may take in only reference data and not any output of the global correction module 110).

The local correction module 120 preferably explicitly models the effects of local parameters on GNSS navigation. These parameters preferably include tropospheric and ionospheric effects (which are not directly dependent on reference station but vary spatially/temporally), receiver clock error, receiver hardware bias, receiver antenna phase windup/PCO/PCV (which are unique to a given receiver/antenna but not directly dependent on location), carrier phase ambiguity, and other position error (which covers effects not otherwise explicitly modeled). Additionally or alternatively, the local correction module 120 may model the effects of any parameters on GNSS signals as received by a mobile receiver or a reference station. Like the global correction module 110, the local correction module 120 may additionally or alternatively maintain/track parameter uncertainty estimates.

In particular, the local correction module 120 preferably models tropospheric and ionospheric effects as a function of receiver position.

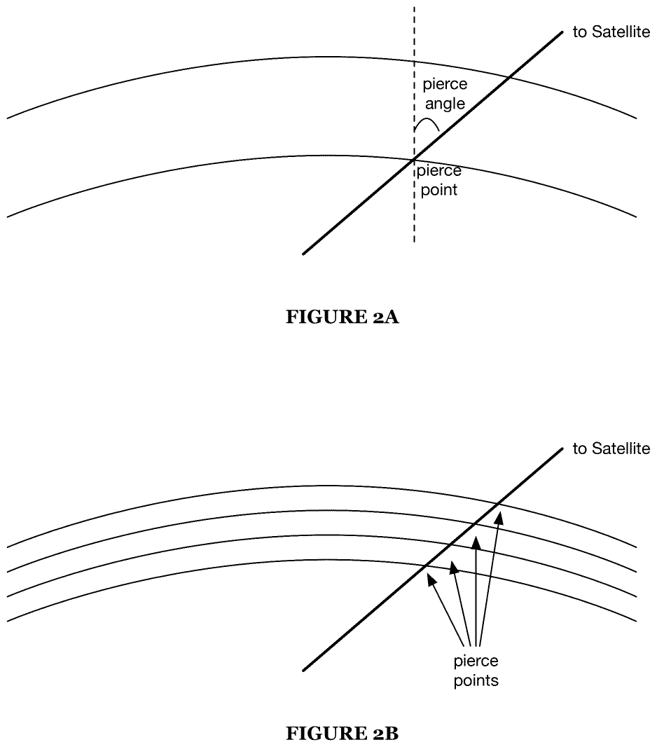

Ionospheric effects may be difficult to model. It is difficult to differentiate the effects on GNSS signals of ionospheric effects from those of receiver hardware bias; however, ionospheric effects tend to vary more quickly in time than receiver hardware bias. Accordingly, local correction modules 120 may attempt to separate ionospheric effects and effects of hardware bias based on rate of change of the combination of these effects. Further, ionospheric effects vary significantly (and not in an easily predictable manner) based not only on position, but also based on the path a GNSS signal takes through the ionosphere. Accordingly, a model of ionospheric effects may need to take each of these factors into account. In one implementation of an invention embodiment, local correction modules 120 model ionospheric effects per GNSS source (e.g., per satellite) as a function of both position (e.g., pierce point—where the line of sight between a receiver and a satellite intersects the atmospheric layer) and pierce angle (e.g., as an analogue for the signal path), as shown in FIG. 2A. Ionospheric effect may also be modeled with respect to frequency. Further, the ionosphere is preferably modeled as one or more thin shells; however, the ionosphere may be additionally or alternatively modeled in any manner. Likewise, ionospheric effects may be modeled in any manner; as opposed to modeling ionospheric effects as a function of position and angle, ionospheric effects may be modeled based on the set of pierce positions for each shell of the ionospheric model, as shown in FIG. 2B.

In contrast, tropospheric effects are not substantially variant in frequency (for most satellite frequencies); further, while tropospheric effects do depend on angle, they typically do so in a predictable manner. Accordingly, local correction models preferably model tropospheric effects solely based on position (e.g., pierce point) with a static correction for angle (roughly corresponding to 1/cos θ where θ is the angle from vertical). Additionally or alternatively, tropospheric effects may be modeled in any manner.

Models of the global correction module 110 and local correction modules 120 are preferably weakly coupled; that is, changes in model in either case propagate to each other, but in a damped manner (which allows for reaction to changing conditions without bad data or reference station loss causing correction accuracy to break down). Additionally or alternatively, the models may be coupled in any manner (or not at all).

Models of the global correction module 110 and local correction modules 120 are preferably maintained/updated via a Kalman filter or Gaussian process, but may additionally or alternatively be maintained/updated in any manner.

The global correction module 110 and local correction modules 120 may use any set(s) of reference sources. For example, the local correction modules 120 may use a strict subset of reference sources used by the global correction module 110 (e.g., the subset of reference sources within a range threshold of a mobile receiver), or the global correction module 110 may use a strict subset of reference sources used by the local correction modules 120 (e.g., the subset of local reference sources with highest accuracy). As a second example, the local correction modules 120 and global correction module 110 may use overlapping reference sources (but neither set a subset of the other). As a third example, the local correction modules 120 and global correction module 110 may use non-overlapping sets of reference sources (i.e., they do not share a reference source). Likewise, these reference sources may receive satellite information from any set(s) of satellites.

The output of the global correction module 110 and local correction modules 120 may be referred to as “pre-corrections” and may be generated in any form usable by the correction generator 140 to generate correction data. Pre-corrections generated by the global correction module 110 may be referred to as “global pre-corrections”, while pre-corrections generated by a local correction module 120 may be referred to as “local pre-corrections”.

In a variation of an invention embodiment, the global correction module 110 includes a differenced ambiguity fixer (DAF) 111 that calculates carrier phase ambiguity for some reference station pairs. This differenced ambiguity fixer may be used, for instance, to help initialize new reference stations in global and local models more rapidly. Alternatively, the DAF 111 may be independent of the global correction module 110.

The interpolator 130 functions to interpolate spatially variant effects of the system 100. In particular, the interpolator 130 preferably functions to transform per reference station models of local tropospheric and ionospheric effects into a local (reference-station independent, but position dependent) model of local tropospheric and ionospheric effects. For example, the interpolator 130 may transform a set of tropospheric effect models corresponding to individual reference locations (each having a known position) to a regularly spaced grid. Additionally or alternatively, the interpolator 130 may function in any manner (e.g., by creating a continuous interpolated model of tropospheric/ionospheric effects rather than a discrete grid, or using some other arrangement of discrete points than a grid pattern). Note that any interpolation technique may be used; for example, kriging may be used (this technique has the advantage of also predicting uncertainty at the interpolated points). In general, the local position dependent model may be referred to as a “unified position-based model” (since it unifies the output of multiple models corresponding to individual reference sources).

The interpolator 130 may additionally or alternatively function to separate ionospheric effects and effects of hardware bias; for example, local correction modules 120 may output to the interpolator 130 both ionospheric and hardware bias estimates (optionally including a term characterizing the correlation between these estimates), and from these estimates attempt to fit a unified (spatially variant) ionospheric model to the data (after which hardware bias estimates for each reference source may be refined). For example, each local correction module 120 (LCMᵢ) may output an ionospheric correction Iᵢ(x, y, z) and a hardware bias correction Hᵢ. At the local correction module 120 these corrections may be improperly separated; e.g., Iᵢ=Iᵢ(ideal)+Δᵢ, Hᵢ=Hᵢ(ideal)−Δᵢ, but because the ionospheric estimates should fit the same model, the interpolator 130 can use measurements from multiple reference sources to refine estimates of both ionospheric correction and hardware bias correction.

The correction generator 140 functions to generate corrections to be used by the mobile receiver. The correction generator 140 preferably generates corrections based on output of the global correction module 110 and the local correction modules 120 for a mobile receiver in a form usable by the mobile receiver. For example, if the mobile receiver can accept PPP corrections, the correction generator 140 may send corrections in the form of PPP corrections (though, in contrast to true PPP corrections, the corrections generated by the correction generator 140 may depend upon receiver position estimate or another spatial term). Additionally or alternatively, the correction generator 140 may send corrections in the form of RTK corrections (e.g., of a virtual reference station), or in any other form (e.g., some sort of local coefficients that are part of a local model). Note that local and global corrections may happen in any order (and may be synchronous or asynchronous). The correction generator 140 may additionally or alternatively send or use correction data in any manner to correct position data (e.g., the correction generator 140 may take as input position data and generate corrected position data rather than a positioning correction to be implemented by, say, a mobile receiver).

The correction generator 140 preferably caches model output and generates corrections using this cache. Accordingly, in the absence of some real-time data, cached data may be substituted (not possible in traditional RTK). Additionally or alternatively, new parameters may be estimated based on a predicted variation in time (e.g., predicted from cached values), or the correction generator 140 may not rely on cached and/or predicted outputs.

The correction generator 140 may additionally or alternatively calculate estimated uncertainty in the generated corrections given uncertainty in the input parameters (traditional PPP/RTK solutions are not capable of doing this).

### 2. Method

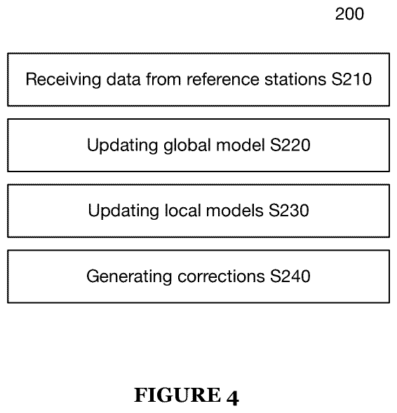

A method 200 for distributed dense network processing of satellite positioning data includes receiving data from a set of reference stations S210, updating a global GNSS correction model S220, updating a set of local GNSS correction models S230, and generating GNSS corrections S240, as shown in FIG. 4.

The method 200 preferably functions in a substantially similar manner to the system 100.

Receiving data from a set of reference stations S210 functions to receive input data used to update global and local GNSS correction models, substantially similar to as described in the system 100.

Updating a global GNSS correction model S220 functions to update a global correction model substantially similar to that of the global correction module 110; this model preferably accomplishes two functions-correcting for global error (i.e., error in GNSS positioning that does not vary substantially in space) and error-checking/seeding local error estimates. Updates are preferably performed as described in the system 100 description.

Updating a set of local GNSS correction models S230 functions to update local correction models substantially similar to that of the local correction module 120; these models preferably correct for spatially local variance of effects on GNSS signals as well as for effects that are specific to particular receivers/reference stations. Updates are preferably performed as described in the system 100 description.

Generating GNSS corrections S240 functions to generate corrections from global and local correction models to be used by a mobile receiver. Generating GNSS corrections preferably includes generating corrections as described in the sections on the correction generator 140; additionally or alternatively, as part of this generation process, S240 may include performing interpolation (as described in the section on the interpolator 130). Likewise, S240 may include caching model output and generating corrections from this cache. Accordingly, in the absence of some real-time data, cached data may be substituted (this is not possible in traditional RTK).

The method 200 is preferably implemented by the system 100 but may additionally or alternatively be implemented by any system for distributed dense network processing of satellite position data.

The methods of the preferred embodiment and variations thereof can be embodied and/or implemented at least in part as a machine configured to receive a computer-readable medium storing computer-readable instructions. The instructions are preferably executed by computer-executable components preferably integrated with a system for distributed dense network processing of satellite position data. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A system for generating global navigation satellite signal (GNSS) corrections comprising:
a set of atmospheric delay filters wherein each atmospheric delay filter receives satellite observations from a reference station and estimates an atmospheric delay at a location of the respective reference station, wherein each atmospheric delay filter is associated with a unique reference station;
a nonlocal atmospheric modeler that receives the set of atmospheric delays estimated by the set of atmospheric delay filters and estimates a model of the atmosphere over a region spanning a geographic coverage region based on the set of reference stations; and
a correction generator that generates the GNSS corrections from the model of the atmosphere and spatially-invariant delays.

2. The system of claim 1, wherein the set of atmospheric delay filters, the nonlocal atmospheric modeler, and the correction generator are implemented on a networked distributed computing system.

3. The system of claim 1, wherein the set of atmospheric delay filters further estimates the atmospheric delay leveraging the spatially-invariant delays.

4. The system of claim 3, wherein the spatially-invariant delays comprise delays arising from: satellite clock error, satellite orbit error, satellite hardware bias, phase center offset (PCO), and phase center variation (PCV) for each of a set of satellites; wherein the set of satellites is used to generate the position of a mobile receiver.

5. The system of claim 4, wherein the spatially-invariant delays further comprise delays arising from solid earth tides, solid earth pole tides, and ocean tidal loading corresponding to a given time and spatial region; wherein the position of the mobile receiver is calculated for the given time and spatial region.

6. The system of claim 1, wherein each atmospheric delay filter of the set of atmospheric delay filters further:
estimates a hardware bias effect for the respective reference stations; and
separates the atmospheric delays from hardware bias effects based on rate of change of the atmospheric delays and the hardware bias effects.

7. The system of claim 6, wherein the nonlocal atmospheric modeler further refines the separation of the atmospheric delays from the hardware bias effects.

8. The system of claim 1, wherein the atmospheric delays comprise ionosphere effects, wherein the ionosphere effects are modelled using a multi-shelled model.

9. The system of claim 8, wherein the ionosphere effects are modelled as a function of pierce point and pierce angle for each shell of the multi-shell model.

10. The system of claim 9, wherein the ionosphere effects are further modelled as a function of satellite signal frequency.

11. The system of claim 9, wherein the atmospheric delays further comprise tropospheric effects, wherein the tropospheric effects are modelled only as a function of pierce point with a static correction for the pierce angle.

12. The system of claim 1, wherein each atmospheric delay filter estimates the respective atmospheric delay using carrier-phase ambiguity resolved satellite observations.

13. The system of claim 12, wherein each atmospheric delay filter determines an integer-valued carrier phase value for satellite observations processed by the respective atmospheric delay filter.

14. The system of claim 1, wherein the correction generator further estimates uncertainty in the GNSS corrections based on uncertainty in the atmospheric delays or the spatially-invariant delays.

15. The system of claim 1, wherein the nonlocal atmospheric modeler estimates the model of the atmosphere using kriging.

16. The system of claim 1, wherein the nonlocal atmospheric modeler estimates the model using a Gaussian process.

17. The system of claim 1, wherein the correction generator generates the GNSS corrections in the form of precise point positioning (PPP) corrections or satellite observations for a virtual reference station.

18. The system of claim 1, further comprising a spatially-invariant delay filter that receives satellite observations from a set of reference stations and estimates the spatially-invariant delays.

19. The system of claim 18, wherein the set of reference stations are distinct from the reference stations used by the set of atmospheric delay filters.

20. The system of claim 1, wherein the correction generator is configured to transmit the GNSS corrections to mobile receivers, wherein the mobile receivers use the GNSS corrections to determine a position of the mobile receiver.
